(19) United States
(12) Patent Application Publication
(10) Pub. No.: US 2011/0078209 A1
(43) Pub. Date: Mar. 31, 2011

(54) SEMI-TAILORED STANDARD CLOTHING SYSTEM

(76) Inventor: Claus Rusberg, Silkeborg (DK)

(21) Appl. No.: 12/736,469

(22) PCT Filed: Apr. 11, 2008
(86) PCT No.: PCT/DK08/00130

§ 371 Date: Nov. 18, 2010

(51) Int. Cl. G06F 17/30

(52) U.S. Cl. 707/802; 707/E17.044

(57) ABSTRACT

Ready made clothes sizing system wherein three specific measurements of the wearer is used as input into the system, where the system further comprises a number of population related tables, where the tables contain measurement data correlated to each specific population, and where each specific table for each size contains five or more sets of data relating to typical body shapes within that specific selected population, and where further for each of the five or more sets of data the system comprises five or more specific sub-sizes, relating to five or more specific body shapes, whereby the system based on three inputs generates/outputs a wearer specific size code.

### FIELD OF THE INVENTION

The present invention concerns a ready-made clothes sizing system by which it is possible to determine ones clothing size from very few body measurements which are correlated into a statistical analysis of the body-shape of a population to which the person belongs and in this manner a better fitting clothing item is provided.

### BACKGROUND OF THE INVENTION

Throughout the world a number of different sizing systems exist such that customers will be able to go into a shop, ask for a certain size and buy a piece of clothing which for off-the-rack clothes tends to fit that person. By the term off-the-rack clothes is meant prefabricated clothing made in certain standard sizes where the difference sizes correspond to different body measurements, typically an item of clothing, for example a pair of pants, will have a size relating to the waist width and the length of the legs. For shirts it is usually a chest measurement and for men's shirts it is usually a neck measurement and then two varieties, standard length sleeves or extra length sleeves.

This manner of pre-manufacturing clothing where each clothing item in a size 42 is supposed to fit everybody having a waist measurement corresponding to size 42, will in fact only properly fit very few of the bodies being a size 42.

International research indicates that approximately 70% of all women do not feel that they get a satisfactory fit from the standard sizes which are offered in most shops. With the typical assortment of sizes offered for example in women's clothing, which are the sizes 36-46, these pieces of garment will typically only fit properly approximately 35% of the market. This in turn means that 65% of the market will be buying items of clothing which fit them very poorly.

Another aspect is the fact that larger segments of the population are growing bigger due to a variety of factors, such as for example not enough exercise and bad diets cause larger and larger portions of the population to become overweight. Therefore the vanity factor comes into play in that having to buy clothes in the large sizes such as from 46 and upwards and XL, XXL and the like is not very flattering and does not stimulate that person's self-esteem. As a consequence some manufacturers of clothing have changed their clothing size system such that they mark clothes size “small” which in fact are size “large” and in this way artificially shifts the entire size system solely for the buyer's vanity.

In the United States alone the organization Size USA estimated that the vanity sizing problems give rise to an approximate loss in turnover corresponding to approximately 25 billion USD a year.

A further aspect of the clothing industry is the fact that different countries have different size system such that in France for example they will have one type of measurement, in England a second type, and in Scandinavia a third type which altogether make it difficult to buy clothes manufactured from a foreign manufacturer, where you are not familiar with the sizing system. In Europe this has resulted in the fact that a number of clothing companies provide their garments with size information recognizable in a number of countries. In order to counter this, the European Union has tried to establish a uniform system for sizing garments throughout the European Union, but has so far failed to come to a consensus with all the players in the market.

In the art a number of systems for providing exact measurements of a person and relate those measurements to a size system, has been suggested. For example in EP1887897 a digital belt incorporating a measuring tape is suggested, whereby a size depending on the waist measure is displayed in the device. An associated computer system, will be able to treat that measurement along with further input from the customer, and in this manner derive at a suitable size indication. This system however requires that the belt like tape measure is available, and the computer system as well. This in turn requires a special investment from the shop in the hardware, and the system is not applicable to any brand, which inevitably will cause the cost of the system to be borne by the sold clothing items.

Another example is known from US2004083142, which method includes a full body scan, categorizing the body shape and selecting try-on size and reference clothing before arriving at the particular clothing items which will fit that person. In addition to being a very cumbersome method, involving relatively expensive and large equipment in the shape of a body-scanner, the system also suggests that the item of clothing must be altered in order to achieve the desired fit.

### OBJECT OF THE INVENTION

It is consequently an object of the present invention to provide a clothes sizing system and garments manufactured according to the clothes sizing system which take into account the fact that a size 42 may cover a wide variety of body shapes and sizes, and by taking into account that in particular the body shape of females in one population may generally differ from the body shape in another population a clothes sizing system is provided by which approximately 80% of the customers will have clothing items with an improved fit compared to items provided today. The remaining 20% will be able to order clothing simply by having 3 measurements transmitted into the systems, whereby their unique size will be registered and clothing manufactured according to these three measurements.

In comparison to prior art systems the novel and inventive system shall in use be simple, in-expensive and with a high degree of success in fitting the person to the garment.

### DESCRIPTION OF THE INVENTION

This object is addressed by the invention by providing a ready-made clothes sizing system wherein three specific measurements of the wearer is used as input into the system, where the system further comprises a number of population related tables, where the tables contain measurement data correlated to each specific population, and where each specific table for each size contains five or more sets of data relating to typical body shapes within that specific selected population, and where further for each of the five or more sets of data the system comprises five or more specific sub-sizes, relating to five or more specific body shapes, whereby the system based on three inputs generates/outputs a wearer specific size code.

The basis of this system is a statistical distribution of specific body shapes within a population. For example, when the system is applied to pants/trousers, the three measurements will typically be waist, hip and body height. With these three input values the statistical distribution of body shapes will have been configured in a table such that the data will be grouped in for example five categories, for example two categories for slim hips, one for normal hips and two for larger hips such that a size 40 for example in a standard clothing size system would indicate a waist measurement of 80 cm and no more, but with the present system a size 40 with the added information about the body shape and the body height would provide 25 different combinations for a size 40.

An example of this will be explained below with reference to the detailed description referring to the figures, but it is clear that by solely measuring three key measurements for trousers/pants relating to waist, hips and body height, it will be possible for the consumer of a specific population to select between 25 different shapes within each size category.

In a further advantageous embodiment of the invention the wearer specific size code is derived from a population specific set of data and comprises the standard clothing size, a body shape indicator and a height interval indicator.

Statistical analysis of different populations has indicated that in particular the female body shape varies considerably. For example, British ladies tend to have more of a “pear” shape compared to German ladies. A standard size 40, not using and being manufactured according to the present invention will for example for a British lady be tight-fitting around the hips and fit a German lady correctly, and if a British lady has a good fit, it will be loose-fitting to a German lady. This is caused by the statistical differences in the specific populations, here the specific populations being resp. the British and the northern European. The system therefore takes this into account when designing the clothes sizing system for each specific population such that there will be a “British” size 40 and a “German” size 40. And naturally within those population specific sizes there will be sub-sizes accordingly, thus the 25 different sub-sizes 40.

In a further advantageous embodiment the body shape indicator for trousers and/or jeans relates to smaller hips, normal hips or larger hips and where the height interval indicator is adjusted to intervals relevant for the majority of each specific population.

Applicant's research indicates that particularly for the female body the ill-fitting feeling for the customer is particularly experienced if the hip-length ratio is not correct. It is therefore an important aspect to work out the sizes and particularly the sub-sizes such that this relationship is correlated to that specific population in order to make well-fitting garments.

Therefore, in a further advantageous embodiment, the sizing system provides for each specific population twenty five different sub-sizes for each standard size. In this manner it is possible to take into account any variations in shape for the majority of the population by grading the clothing items according to the system.

It is clear that in any population there will be bodies which fall outside any “standard size”. The present system, will statistically provide well fitting garments to approx. 80% when only providing a limited number of sizes and sub-sizes, specific for a specific population.

In a still further advantageous embodiment of the invention the manufacturing unit comprises predefined templates corresponding to three hundred and seventy five different sizes, each size being uniquely identifiable by three specific body measurements, whereby fifteen standard sizes (32 to 60) each is sub-divided into twenty five body shape specific sub-sizes, wherein the templates may be physical cutting models, or be stored in a processor for operating a cloth cutting robot.

In order to be able to provide clothing items having the size indications of the system, it is necessary to be able to produce the clothing items. For this purpose the manufacturer uses templates and with the software control and cutting robots available in most manufacturing units of this type the specific sizes and sub-sizes will be stored preferably as software used as input for the robot, such that the manufacturing of the twenty five sub-sizes relating to one standard size will be controlled and carried out automatically depending on the input from the customer.

In practice, by analysing statistical material relating to the body shape configuration and distribution belonging to a specific population the analyses indicate that by stocking approximately forty eight different sub-sizes approximately seventy five to eighty percent of the market will be able to walk into a shop and buy off the rack, well-fitting clothes when they are sized according to the inventive system.

The invention is also directed at a clothing item manufactured according to the system where each piece of clothing is marked with a code identifying standard size and at least two codes indicating sub-sizes relating to body specific measurements correlated to statistical date for a specific population.

This implies that for example a pair of jeans will be provided with a code consisting of a standard size, for example 42, a number or colour code relating to the hip size and shape and the height indicator for the entire body height such that it becomes very easy for the customer to identify the properly fitting piece of clothing regardless of the type of clothing.

In a further advantageous embodiment the clothing item suitable to be manufactured according to the system is any of the following: ladies trousers, jeans or pants, shirt or jacket, men's trousers, pants, jeans, shirt, jacket.

### DESCRIPTION OF THE DRAWING

The invention will now be explained with reference to the accompanying drawing wherein

FIG. 1 illustrates a female body

FIG. 2 illustrates a table over the sizing system

The invention will be explained with reference to women's sizes, but it is obvious that the system is just as applicable to men's sizes. Women's sizes, however, tend to vary more, and also, statistically, women are more concerned with the way their clothes fit.

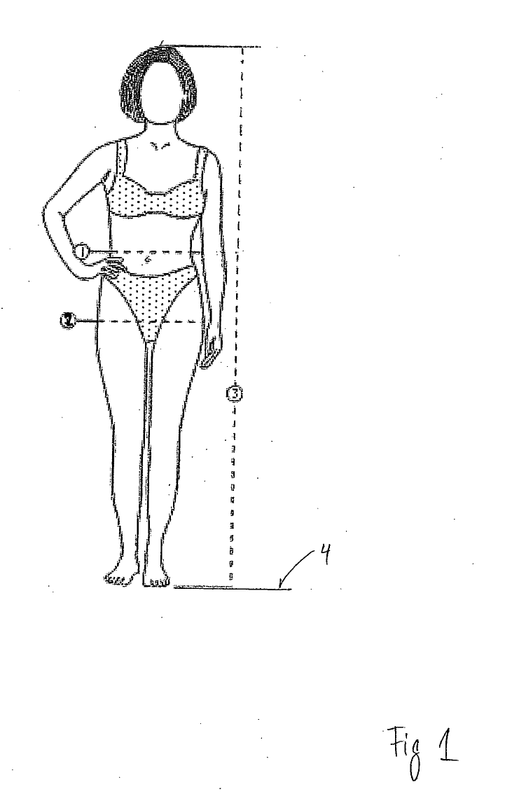

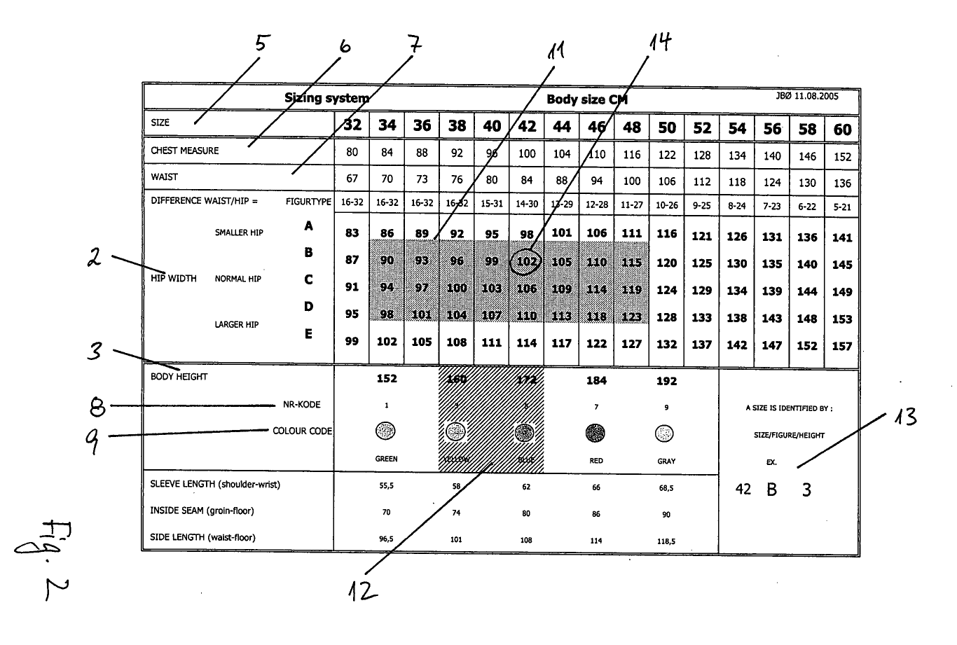

In FIG. 1 is illustrated a schematic body shape of a woman. By 1 is indicated the waist measurement, 2 the hip measurement and 3 the body height from a floor level 4. With these three measurements it is possible to correlate with the statistical material relating to a specific population such that by using the table in FIG. 2 a precise, well-fitting size may be identified.

In the context of this invention the formulation “specific population” is not necessarily related to a national population, but more to a population which genetically is very close, i.e. where the body shapes only tend to differ very little. Such a population may be part of a population in a country or may be spread over a plurality of countries. For example, statistically an example of a specific population may be the body shapes in the northern region of Europe comprising parts of Norway, Sweden, Denmark, Northern Germany, where one size fitting system may be adequate in order to fit women in this population. The table illustrated in FIG. 2 represents the sizing chart for this population.

Turning to FIG. 2 the normal standard sizes 5 are indicated ranging from size 32 in steps of two up to size 60. Corresponding chest and waist measures are listed in the table lines 6, 7.

The hip width corresponding to the measurement indicated by 2 in FIG. 1 is subdivided into 5 categories A-E such that small hips are categorized as A and B, normal hips as C and large hips as D and E.

The body height 3 is indicated in a separate part of the table where for the Northern European region body heights of 152, 160, 172, 184 and 192 are selected as covering the vast majority of adult women bodies. As an alternative to indicating the height in cm the height measurement may be given an additional code, for example a number code 8 or a colour code 9.

By analyzing the statistical data it has become evident that for example for the Northern European region mentioned above selecting forty eight sub-sizes will provide well-fitting garments for approximately 80% of the female population in that region. The sub-sizes 10 selected for the Northern European region are illustrated by the hatched box 11 in the sub-size section 10. By selecting the hip width B, C, D and the sizes 34-48 as illustrated by the hatch box 11 in combination with two body heights, namely body height 160 and 172 (also hatched 12) a selection of forty eight different sub-sizes being categorized in eight standard sizes 5 has proven to cover approximately 80% of the market.

Each specific piece of garment may be equipped with a specific sub-size code as illustrated by 13. The code in this example comprises a number “42”, a letter “B” and a number “3”. The number “42” corresponds to the standard size 5, the letter “B” corresponds to a hip width 2 and the number “3” corresponds to a body height, in this example the body height 160 cm. The garment will be marked with this code which will be a unique sub-size corresponding to a size 42 where the wearer has a smaller hip and is approximately 160 cm high.

Returning to the hip width 2 the numbers in the sub-size section 10 of the table correspond to the measured hip width 2. Therefore, a size “42” according to the inventive sizing system may have a hip width spanning from 98 cm to 114 cm, i.e. corresponding to the letters A-E. The specific size code 13 in this instance corresponds to a hip width of 102 cm indicated by the circle 14 in the sub-size section 10. This number is found by following the column corresponding to size 42 and the horizontal row corresponding to smaller hip B. In turn, this means that when a customer walks in and is measured to have a waist measure 7 of 84 cm corresponding to a normal size 42, the hip measurement will provide the hip indication B and a simple body height measurement 3 will give the indication of the number code 3 which could also be replaced as exemplified by the yellow dot by a yellow colour. Therefore, the code 13 provides a very specific and detailed sub-size which in comparison to an ordinary piece of garment having size 42 may be expected to fit better than the standard issues.

1. Ready made clothes sizing system wherein three specific measurements of the wearer is used as input into the system, where the system further comprises a number of population related tables, where the tables contain measurement data correlated to each specific population, and where each specific table for each size contains five or more sets of data relating to typical body shapes within that specific selected population, and where further for each of the five or more sets of data the system comprises five or more specific sub-sizes, relating to five or more specific body shapes, whereby the system based on three inputs generates/outputs a wearer specific size code.

2. Ready made clothes sizing system according to claim 1 wherein the wearer specific size code is derived from a population specific set of data and comprises the standard clothing size, a body shape indicator and a height interval indicator.

3. Ready made clothes sizing system according to claim 2, wherein the body shape indicator for trousers and/or jeans relates to smaller hips, normal hips or larger hips and where the height interval indicator is adjusted to intervals relevant for the majority of each specific population.

4. Ready made clothes sizing system according to claim 1 wherein for each specific population the system provides twenty-five different sub-sizes for each standard size.

5. Ready made clothes sizing system according to claim 1 wherein the manufacturing unit comprises predefined templates corresponding to three hundred and seventy five different sizes, each size being uniquely identifiable by three specific body measurements, whereby fifteen standard sizes (32 to 60) each is sub-divided into twenty five body shape specific sub-sizes, wherein the templates may be physical cutting models, or be stored in a processor for operating a cloth cutting robot.

6. Clothing item, manufactured according to the system of claim 1, wherein each piece of clothing is marked with a code identifying standard size and at least two codes indicating sub-sizes relating to body specific measurements correlated to statistical date for a specific population.

7. Clothing item, according to claim 6 where the clothing item is any of the following: ladies trousers, jeans or pants, shirt or jacket, men's trousers, pants, jeans, shirt, jacket.
